(19) United States
(12) Patent Application Publication
(10) Pub. No.: US 2003/0061266 A1
(43) Pub. Date: Mar. 27, 2003

(54) Project workflow system

(76) Inventor: Norman Ken Ouchi, San Jose, CA (US)

Correspondence Address: NORMAN KEN OUCHI, 20248 VIEW CREST CT, SAN JOSE, CA, 95120, US

(21) Appl. No.: 09/966,844

(22) Filed: Sep. 27, 2001

(51) Int. Cl. G06F 9/00; G06F 9/46

(52) U.S. Cl. 709/106; 709/313

(57) ABSTRACT

This invention is related to project planning and management systems and in particular to the control and tracking of the execution of the process steps that comprise a project. In the present invention, a project is divided into tasks for which the time and resources are estimated, the connections among the tasks established, and from these the overall schedule and resources calculated. A workflow route segment is a sequence of process steps to implement a task. A route segment is developed for each task and the route segments are connected based on the task-to-task connections to form a project route. The execution of the project is tracked by relating the completion of a step of the project route to the completion of a portion of the related task. If the project is re-planned and new task-to-task connections are created, a new project route is created by connecting the route segments related to tasks using the new task-to-task connections.

### CROSS-REFERENCE TO RELATED APPLICATIONS

None

### STATEMENT REGARDING FEDERALLY SPONSORED RESEARCH OR DEVELOPMENT

None

### FIELD OF THE INVENTION

This invention is related to project planning and management systems and in particular to the control and tracking of the execution of the process steps that comprise a project.

### BRIEF SUMMARY OF THE INVENTION

In the present invention, a project is divided into tasks for which the time and resources are estimated, the connections among the tasks established, and from these the overall schedule and resources calculated. A workflow route segment is a sequence of process steps to implement a task. A route segment is developed for each task and the route segments are connected based on the task-to-task connections to form a project route. The execution of the project is tracked by relating the completion of a step of the project route to the completion of a portion of the related task. If the project is re-planned and new task-to-task connections are created, a new project route is created by connecting the route segments related to tasks using the new task-to-task connections.

### BACKGROUND OF THE INVENTION

Large projects such as building a dam or road, developing a new airplane or computer system, or other major undertaking requires significant effort to plan and execute. Project management techniques divide the project into smaller elements called tasks where the time and resources for each task can be estimated. The connections and relationships between the tasks are established and an overall estimate of the total time and resources can then be made. Examples of the task-to-task connections are, for instance, when Task 1 completes then Task 2 can start or Task 1 and Task 3 can execute in parallel but both must complete before Task 4 can start. Powerful concepts such as PERT, Program Evaluation and Review Technique were developed to chart and schedule a complex set of interrelated activities and identify the sequence or path of the most time-critical events in the process. Critical path analysis and other project management tools were developed based on PERT. Software programs such as Microsoft Project, Micro Planning International X-PERT, and many other programs and tools were developed to automate these techniques and concepts. Almost every project is now planned using these tools. In addition, these tools and techniques are used to re-plan projects when significant changes occur due to changes in the schedule targets or mismatches between the planned execution and actual execution. In re-planning a project, the connections between the tasks may change, tasks may be added or deleted, tasks may change in duration or resources. FIG. 1 illustrates a very simple PERT chart where the lengths of the blocks with task names represent the relative estimated duration of the task. In the illustration, Task A is 3 units in duration, Task B is 2 units, and Task C is 6 units. The arrows indicate the connections between the tasks. Task B starts after Task A completes; Task C starts after Task B completes. From the PERT chart, the estimated total time is 11 time units. The resources required for each task can be estimated by multiplying the resources for each task by the time for the task. The resources for the project are the sum of the resources for the tasks.

However, while the planning of a project is well supported with technology, the tracking of the execution of a project is not. Considerable effort is required to measure the progress of each task. In many organizations, periodic meetings (daily, weekly, etc.) are held to determine the progress of tasks and from that the overall project. Microsoft Project and other software programs have added e-mail and web interfaces to collect the progress information to aid in the tracking but these have not been effective in closing the feedback loop so that the project execution can be as effective as the project planning. One weakness of the project planning has been the lack of definition of intermediate milestones within a task and the linking of task events to the reporting of task progress to the project management system. Planning and tracking events to this level has not been part of the planning process. Thus, many tasks are reported “90%” complete for a very long time but never seem to complete. Project planning is done at a macro level while execution must be done at a micro level.

Workflow concepts and tools permit the planning, controlling, and tracking of the step-by-step execution of a process. Workflow was originally applied to document processing where the processes were well defined and static. Insurance claims processing and loan application processing are examples of processes where workflow has been used in the past. In parallel, workflow technology has been applied to the manufacturing shop floor where the controlling and tracking of manufactured items in a manufacturing line are similar to the controlling and tracking of documents in an insurance claim process. Workflow technology has evolved so that it can be applied to most processes that have process steps that are executed by people or computer controlled equipment. A workflow can be used to implement a process by defining the steps in the process and the sequence of steps. The sequence of steps is called a route. A route can define a process with conditional branching to implement business processes such as an “Approve I Reject” process step or an iterative process that may require loops similar to Do While or For Loop of many programming languages. A route can implement parallel sub-routes including the splitting or “forking” of a route into parallel sub-routes and joining of parallel sub-routes. The fork and join steps may have conditional functions. Parallel computing has a very rich base of knowledge from which the construction of parallel workflow routes may draw. The route structure supports all the basic elements of a Turing machine so the Computer Science of computability may be applied to workflow. The workflow route is similar to a computer program and the workflow engine is similar to a computing engine that executes routes as programs. The key to workflow is the development of the route. Workflow definition can be developed using graphical tools and process modeling tools. Workflow not only is used for the definition of a process but also for the execution and tracking of the process. When a step in a route is completed, the workflow engine determines from the route the next step and sends the work to the person or machine responsible to complete the step. FIG. 2A illustrates a three-step route for a travel expense approval process where the traveler creates the travel expense request in Step 1, the manager approves or rejects the request in Step 2, and if approved, the travel expense request moves to Accounts Payable for payment to the traveler in Step 3. If the expense request is rejected, it is returned to the traveler at Step 1. Since the workflow is executing in real time, each step can be timed and if a step does not complete within a preset time, an alert using e-mail, pager, phone, etc. can be sent to the appropriate people to fix the cause of the delay.

Since the workflow route is a step-by-step definition of a process, the time to execute the process can be estimated for planning purposes by summing the estimated time for each step and can be measured during execution. However, it is difficult to envision trying to create a workflow route for a large project. The project management system would have to treat each workflow step as a task and project management would really become micromanagement. On the other hand, the creation of the workflow route requires micro-level planning since the step-by-step process must be established and workflow has the power of control and tracking the execution of the process. However, planning a project at the workflow level of detail is not reasonable for larger projects since each step would be treated as a PERT task and the number of tasks would be formidably large.

What is desired is a project workflow system and process that provides the planning benefits of project techniques and tools and the process control and tracking of workflow systems.

### BRIEF DESCRIPTION OF DRAWINGS

FIG. 1 illustrates a PERT chart for three tasks with the time line and task connections.

FIG. 2A illustrates a workflow route for a three-step process with a decision step.

FIG. 2B illustrates a task and a related workflow segment.

FIG. 3A illustrates three tasks, the related route segments and the task-to-task connections.

FIG. 3B illustrates the connected project route.

FIG. 4A illustrates a task and related route segment with messages from each step to the project management component.

FIG. 4B illustrates the three tasks and the connected route segments with messages from each step.

FIG. 5A illustrates a task with related route segment where the project management component initiates the route segment.

FIG. 5B illustrates the three tasks where each task is initiated by the project management component using a message and each step in the workflow segment sends a message to the project management component.

FIG. 6A illustrates a task and related route segment where selected steps send messages.

FIG. 6B illustrates three tasks where selected steps send messages.

FIG. 7A illustrates three tasks where Task D replaced Task C.

FIG. 7B illustrates four tasks where Task E and Task F replaced Task D.

FIG. 8 illustrates the block elements of a project workflow system.

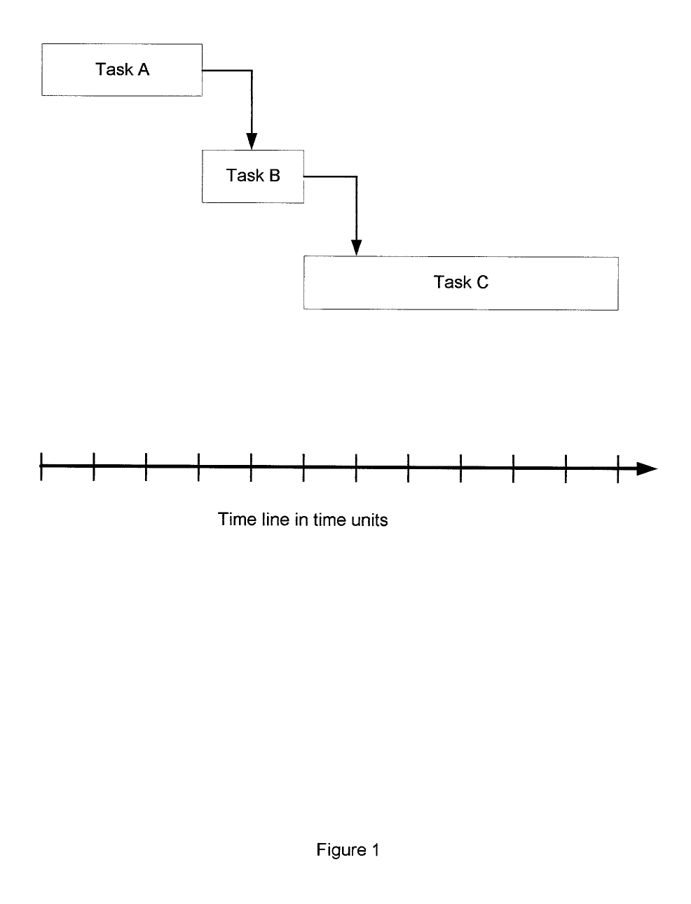

### DESCRIPTION OF THE INVENTION

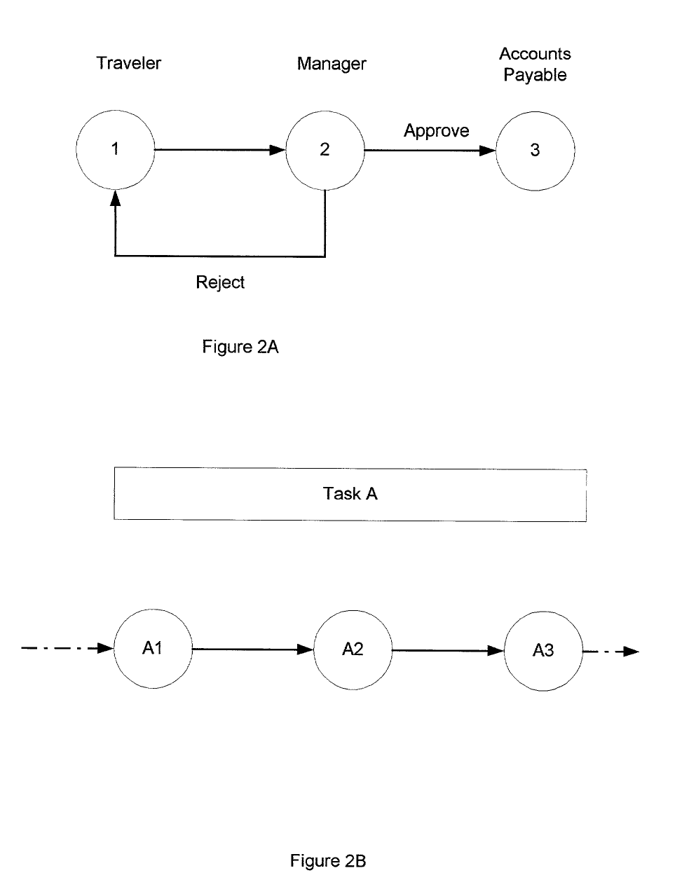

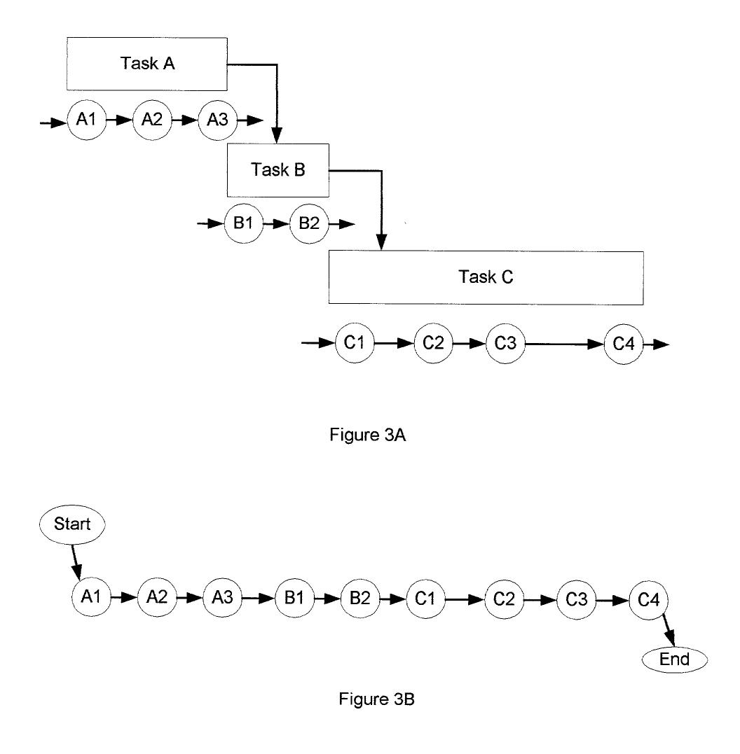

A project is divided into tasks and the connections between the tasks are determined. For the present invention, for each task, a workflow route segment is developed and associated with the task. The task-to-task connections are used to connect the route segments to form a route for the project. FIG. 2B illustrates the route segment that supports the process for Task A where three steps: Step A1, Step A2, and Step A3 when executed, complete Task A. The initial connection to Step A1 is not connected and the connection from the last step, Step A3 is also not connected. FIG. 3A illustrates the tasks with associated route segments and the connections between the tasks. Task A is related to a three step route segment with steps A1, A2, A3; Task B with steps B1 & B2; Task C with steps C1, C2, C3, & C4. Task A connects to Task B which connects to Task C. The task-to-task connections are used to connect the route segments to generate the project route illustrated in FIG. 3B. Step A3 is connected to Step B1, the first step for the route segment associated with Task B, and Step B2, the last step in the route segment is connected to Step C1, the first step in the route segment for Task C. A START step is connected to Step A1 to begin the workflow route and an END step is connected to Step C4 to complete the workflow route. The route segments are illustrated as simple linear routes but it should be clear to those skilled in the art that the route segments are to support the business process of the task and can be arbitrarily complex with conditional branches, loops, parallel route segments, etc. In addition, the route steps need not be executed by people but can be designed with interfaces into software programs and other external programs communicating using local area networks, wide area networks, the Internet and Intranets. For instance, for a building development project, a step could be the filing of a permit application to the county over the Internet to a county web site. The web submission could trigger the completion of the route step or if the integration to the county web screen were not available, the workflow action would be a manual entry in a workflow screen.

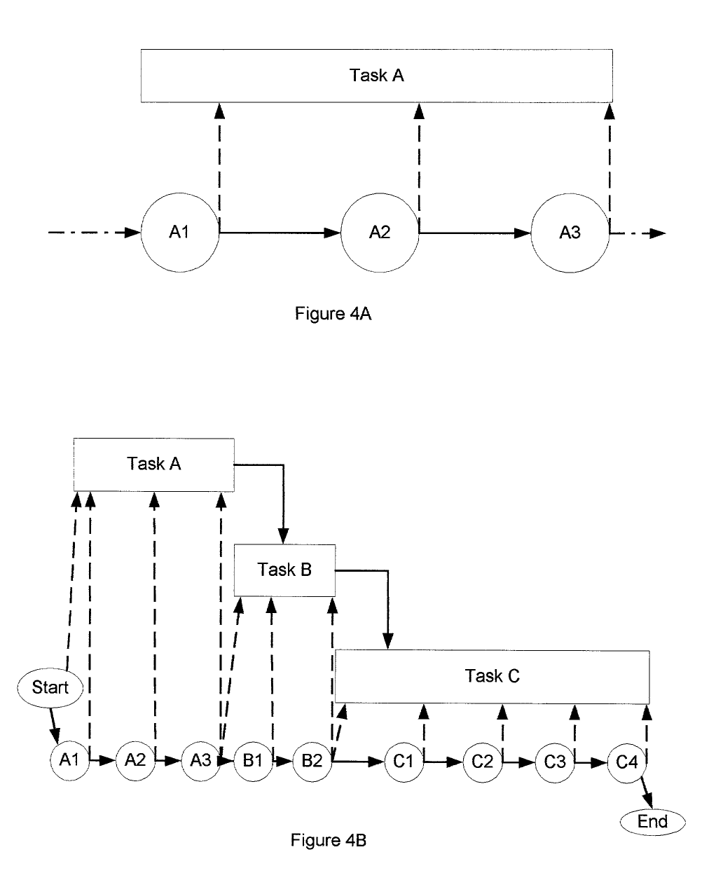

In addition to controlling the process steps of a task, the route segment also provides tracking information to the project management component by sending a message at the completion of each process step. The route segment may be as simple as a screen to report the completion of a task. This will help with collecting timely feedback on the execution of the tasks of a project. The power of the workflow technology can be used for simple feedback that will make project management technology more effective. In a first embodiment, the workflow component is adapted to extract the task-to-task connections from the project management component and to send messages based on the completion of a route step. The project management component is adapted to accept messages that are used to start a task or to update the progress of a task that was started. FIG. 4A illustrates a first method of integration of the project management component with the workflow component that uses messages, shown as dashed arrows, from the workflow component to the project management component. Messages are sent by the workflow component at the end of each route step: Step A1, Step A2, and Step A3. At the completion of route Step A3, an additional message is sent to initiate Task B in the project management component. In addition to the message sent at the beginning of a task and message at the completion of a task, intermediate steps may send messages to indicate partial completion of the task. The fraction of completeness need not be linear. For example, the route segment associated with Task A has three steps: Step A1, Step A2, and Step A3. Completion of Step A1 need not be an indication that ⅓ of Task A has been completed but may be any fraction as determined when the route segment was developed. The workflow component extracts the task-to-task connections from the project management component and links the route segments associated with each task to connect them to form the route for the project. FIG. 4B illustrates the connected route for the three-task project and the messages, shown as dashed lines, sent by the workflow component to the project management component.

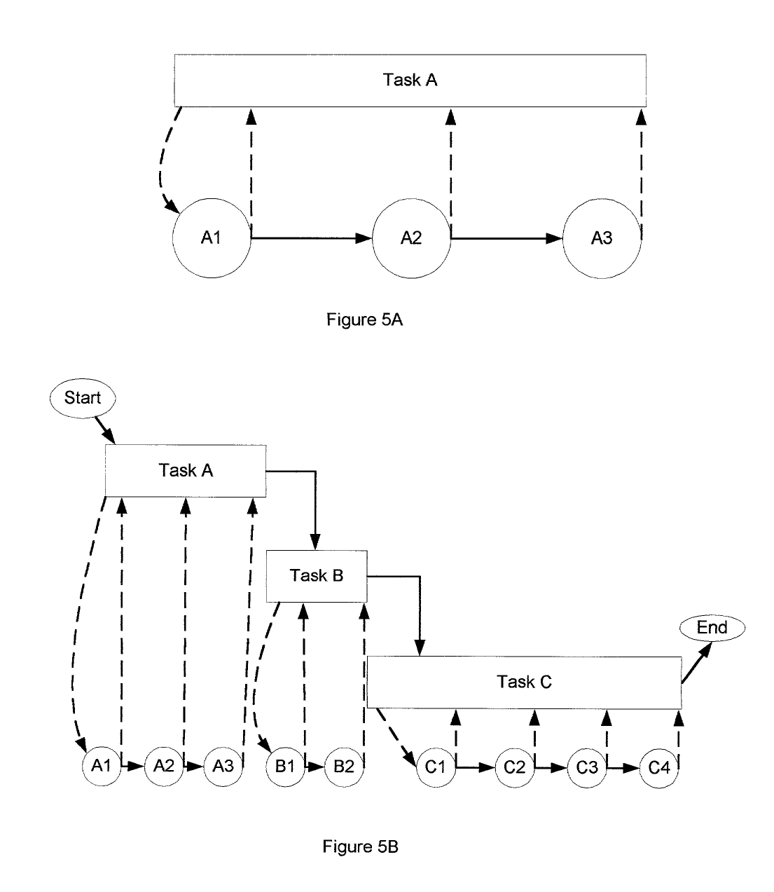

FIG. 5A illustrates a second method of integration between the project management component and the workflow component where the project management component has been further adapted to initiate the workflow route associated with each task. The workflow component need not extract the task-to-task connections in this method. In FIG. 5A, to begin Task A, the project management component sends a message to the workflow component to initiate the route segment related to Task A by starting Step A1. At the completion of Step A1, the workflow component sends a message to the project management component to post partial completion of Task A. At the completion of Step A2, another message is sent to post further progress of Task A. At the completion of Step A3, a message is sent to post completion of Task A. When Task A is completed, as illustrated in FIG. 5B, the project management component determines from the task connections that Task B is the next task, and sends a message to the workflow component to initiate the route segment related to Task B by starting Step B1. When Step B2 completes, the workflow component sends a message to the project management component indicating that Task B is complete. The project management component determines that Task C is the next task and initiates the route segment related to Task C by sending a message to the workflow component to start Step C1. When Step C4 completes, the workflow component sends a message to the project management component indicating that Task C is complete. The project management component determines that this completes the project and no more messages are sent for this project. In this second method of integration, the project route is not connected in the workflow component as a static route but the route segments are dynamically connected by the project management component by determining the task-to-task connections and at the end of a task, initiating the subsequent task or tasks, or determining that the project is complete. The workflow component can also use this technique and not connect the route segments in a static manner but connect the route segments as needed as described as the process for the project management component.

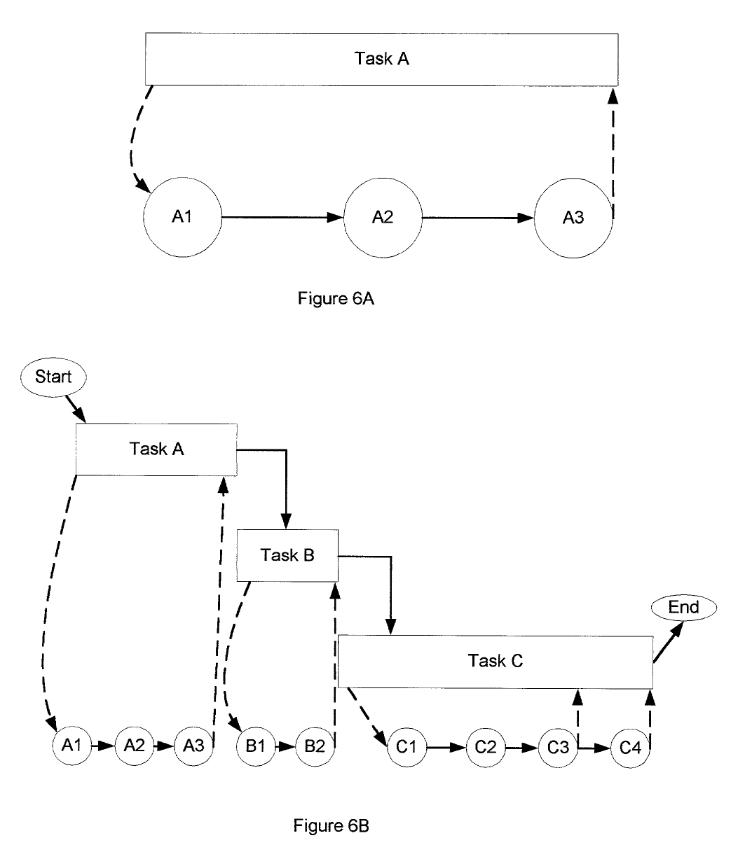

FIG. 6 illustrates that each step in the route segment need not be configured to send a message to the project management component at the completion of the step. The route segments may have many steps including loops and conditional branching and it may not make sense to send the completion of every steps. In fact with loops, the task progress may go “backwards” and the completion of a looping process may be the step that should report progress on the task process. FIG. 6A illustrates the route segment for Task A that sends a message at the completion of Step A3 (and the completion of the route segment for Task A) and not at the completion of Step A1 or Step A2. FIG. 6B illustrates the project route where Task B sends a message at the completion of Step B2 and Task C sends a message at the completion of Step C3 and Step C4.

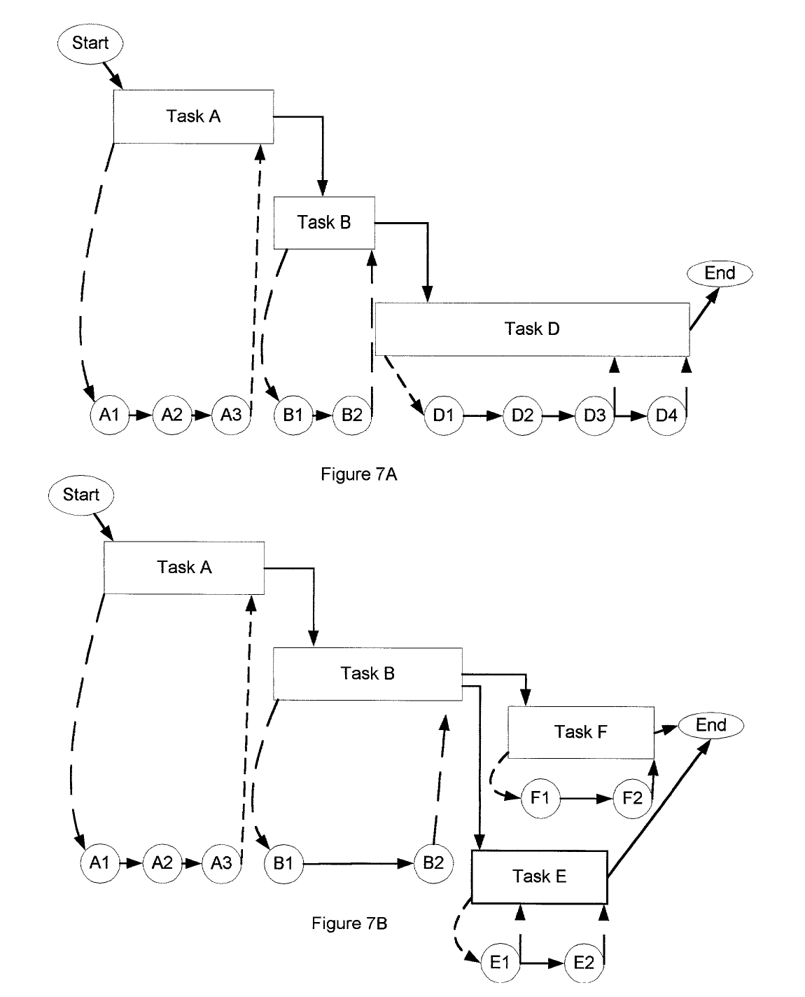

The power of the project management component is not only for planning a project but is also applied in re-planning a project as conditions change. FIG. 7A illustrates the removal of Task C and the insertion of Task D. The project management component determines the task-to-task connections with the change so that at the completion of Step B2, the route segment associated with Task D is initiated starting with Step D1. FIG. 7B illustrates end completion of Task B delayed and Task E and Task F substituted for Task D. When Step B2 completes signaling the completion of Task B, Task E is initiated by starting Step E1. The project management task-to-task connections can indicate a time delay between the completion of a task and the start of the subsequent task. Task F is initiated after the completion of Step B2 and the time delay indicated in the task-to-task connections. The project is completed when both Task E and Task F are completed. Note that in re-planning the project, the project route changed to reflect the changes without altering the route segments. The linkages between the route segments were kept in the task-to-task connections. The macro planning and task connections are determined using the project management component. The workflow component is used to establish the sequence of steps to accomplish each task, to control the sequence of execution of the steps, and to track and measure the actual execution of each step of the task. The task-to-task relationship is determined and kept in the project management component. Thus, each component is used as they were designed and the power of each component is retained. The integration of the capabilities provides a means to plan and re-plan at a macro level and execute and track each task at the micro-level.

The route segment for a task need not be determined until just before use. The planning can be done using the estimates at a task level. As the time for task execution nears, the step-by-step sequence can be determined to form the route segment. The time and resource estimate of the route segment can be compared with the time and resource estimates for the corresponding task in the project management component. If there is a difference, the route segment can be changed or the project re-planned with the new numbers from the route segment. Projects may be planned with the best information available at the time and the project executed with better and more detailed information as that portion of the project moves into the execution time window.

The project management component provides very powerful tools and functions to plan the relationships between the tasks of a project. These capabilities are powerful because of the macro level of the information and the planning processes. The workflow component provided very powerful tools and functions to control and track the execution of a task. These capabilities are powerful because of the micro level of the information and the control and tracking processes. In general, neither component would be effective doing the functions of the other. The integrated project management and workflow components provide the benefits of both while minimizing the weakness of each component. Two methods of integrating the project management component and the workflow component using messages as a means of notification were described. These methods build on the functions in many commercial software programs and minimize the development effort. However, those skilled in the art recognize that the project management component and workflow components may be developed starting from a new base and a different method of integration may be used. For example, the components may share a relational database where the tables of one component may be accessed by the other. Rather than messages as described in this application, the database tables would serve as the integration method. Message queues in the database can be used for notification. The database may have triggers or other sentinel mechanisms to notify when information has changed and will serve as a notification mechanism. However, the objectives would be the same: the project is divided into tasks; the task-to-task connections are determined; a route segment is related to a task; the route segments are connected in accordance with the task-to-task connections to form a project route; the project route is used to control and track the execution of the steps of the tasks and, thus, the project. When a task changes, the corresponding route segment is changed to reflect the task change. When the task-to-task connections change, the connection of the route segments change to reflect these changes. The route segments and connection among the route segments need only be for the portion of the project route in the execution window. The route segment need only be defined and connected just before execution. The route segments for tasks to be executed in the distant future need not be defined until the future becomes closer.

### DESCRIPTION OF PREFERRED EMBODIMENTS

An embodiment of the project workflow component is implemented by interconnecting a project management component and a workflow component using e-mail messages. U.S. Pat. Nos. 5,978,836, 6,170,002, and 6,279,042 by Ouchi describe message based workflow systems where the workflow clients need only e-mail or Internet Web capability and all communications between the workflow engine and the clients use e-mail or Web based messages. A route describes the sequence of steps to implement a process and the workflow engine is called the Form Route Manager. The Form Route Manager receives an e-mail; from the e-mail content determines the route and the step in the route; from these, it determines the next step in the route; updates the step counter; and sends a message to the e-mail address of the person or system that is to execute the next step in the route. Ouchi further describes a step that may be configured such that at the completion of the step the Form Route Manager will send an e-mail message to a designated e-mail address. Ouchi further describes sending an e-mail with specific content to the Form Route Manager as a signal to initiate a route described by an identifier in the e-mail. The Form Route Manager is a description of the workflow component.

In the present invention, a route segment is developed for each task using the workflow component and assigned an identifier. A table relating the task identification and the route segment identification is maintained and accessible to the project management component and the workflow component. Steps in the route segments are configured to send a message to the e-mail address of the project management component with information identifying the task associated with the step and the task progress or completion. Project management systems such as Microsoft Project have a function to request task status in an e-mail and to receive task progress information in a status response e-mail. The e-mail messages from the workflow component uses the format of the status response messages to notify the project management component as the steps in a route associated with a task complete so the task progress can be tracked by the project management component. The route steps that send messages can be selected so that all steps need not send a message. The step that completes a task should be configured to send a message so the project management component is notified of task completions.

Two methods of message-based integrations were described. In the first method, the route segments associated with the tasks were connected in accordance to the task-to-task connections to form the project route kept in the workflow component. In the second method, the connection of the route segments was implemented within the project management component where the project management component determined at the end of a task the next task to initiate and sends a message to the workflow component to initiate the appropriate workflow segment corresponding to the task to be initiated. For an embodiment of the first method, the project management component is adapted to respond to a request message to extract the task-to-task connections of a project and to send it as a message. When a project has been planned or re-planned, the workflow component is adapted to request the task-to-task connections from the project management component and using the task and route segment relationship table, the workflow component connects the route segments in accordance with the task-to-task connections to form the project route. Starting the project workflow starts the project.

For an embodiment of the second method, the project management component is adapted to receive a message indicating the end of a task; determine from the task-to-task connections the next task to start; determine from the task to route segment relationship table the route segment identification related to the next task to start; and, send a message to the workflow component to initiate the route segment related to the next task.

### FURTHER DESCRIPTION OF PREFERRED EMBODIMENTS

The project management component, workflow components, and e-mail systems are programs that execute in computers. Project management system programs are provided by Microsoft and other software vendors such as Micro Planning X-PERT. Microsoft Project will be used to illustrate a project management component in a preferred embodiment. Workflow system programs are provided by BEA Systems, Extricity, and other companies. The BEA Web Logic Process Integration, WLPI, system will be used to illustrate a workflow component in a preferred embodiment. The adaptations of the project management and workflow programs are implemented as software programs written in Java, C++, Microsoft Visual Basic, or a number of programming languages. Microsoft, IBM, and many others provide e-mail system programs. Extricity, Neffish, Tibco, and others provide Business-to-business server programs. Microsoft, Netscape, Apache and others provide Web server programs. Oracle, Microsoft, IBM and other companies provide database system programs. These programs execute in computers manufactured by, for example, IBM, Sun, Dell, and Compaq. The computers may be, for example, PC's, workstations, mainframes, and hand-held computers. The computers may have an operating system such as UNIX, LINUX, Microsoft 2000, and IBM OS/9000. The computer is connected to a network that may be, for example, a LAN, WAN, Internet, Intranet, wireless LAN, or wireless Internet.

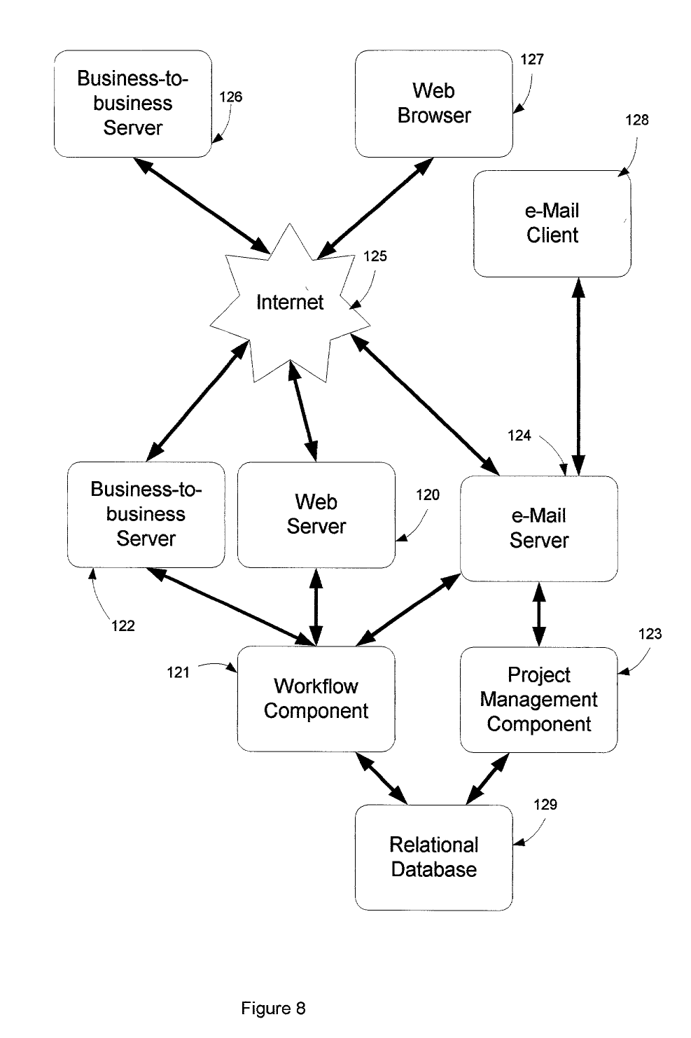

In FIG. 8, the route steps are executed by people at computers, workstations, hand held computers, personal digital assistants, wireless devices such as PC's, phones, PDA's, pagers, etc. that are connected to the Internet 125 or other network. The Web browser 127 and the e-mail client 128 represent these users. Some steps are executed by other systems or programs and are represented by the Business-to-business integration server 122. The workflow component 121 is the interface to the users and programs that execute the route steps and is connected to Web server 120, to Business-to-business server 122, and to an e-mail server 124 as a MAPI, Mail Application Program Interface, client. The workflow component 121 is connected to a Database server 129 where the task identification to route segment identification relationship is maintained. The project management component 123 is connected to the e-mail server 124 as a MAPI client and to the Database server 129 where the task and route identification relationship is maintained.

The workflow component 121 is adapted from a workflow program such as the BEA WLPI by writing programs using Java to create a route segment with an identification, relate the route segment to the associated task identification, and maintain the relationship table in the Database server 129. Programs are written to extend the WLPI functions to implement the message based workflow functions of the Form Route Manager as described by Ouchi in the cited patents. To implement the first integration method where the project route created by connecting the route segments in the workflow component 121, the workflow program is further adapted to request, as an e-mail, the task-to-task connections from the project management component and to use the task-to-task connections in the response e-mail to connect the route segments corresponding to the tasks to form the project route. The project route is initiated using the same mechanism to initiate a route in the workflow component. The implementation of the second integration method does not require additional programs or the added programs needed to implement the first integration method.

The project management component 123 is adapted from a project management program such as Microsoft Project by writing methods and events using Microsoft Visual Basic for Applications, VBA. To implement the first integration method, methods and events are developed to extract the task-to-task connections in response to an e-mail request and to return it as an e-mail. To implement the second integration method, methods and events are developed to receive an e-mail; from the e-mail determine if a task has completed and if a task has completed, determine from the task-to-task connections the next task to start; determine from the task to route segment relationship table in the Database server 129 the route segment identification associated with the next task to start; and, send an e-mail to the workflow component 121 to with the route segment identifier initiate the route segment associated with the next task.

I claim:

1. A project workflow system comprising a project management component and a workflow component wherein the project management component manages the tasks of a project and determines the task-to-task connections and the workflow component processes project routes and route segments whereby each task is related to a route segment that implements the task process and a project route is created by connecting the route segments related to the tasks in accordance with the task-to-task connections.

2. The project workflow system of claim 1, wherein the workflow component notifies the project management component at the completion of a route segment.

3. The project workflow system of claim 1, wherein the workflow component notifies the project management component of progress of a route segment.

4. The project workflow system of claim 1, wherein the project management component receives a request for the task-to-task connections and responds with a reply containing the task-to-task connections.

5. The project workflow system of claim 1, wherein the workflow component creates a project workflow route by connecting the route segments related to tasks in accordance with the task-to-task connections.

6. The project workflow system of claim 1, wherein the project management component receives notification of the completion of a route segment from the workflow component; determines from the task-to-task connections the next task; determines the route segment related to the next task; and notifies the workflow component to initiate the route segment related to the next task.

7. The project workflow system of claim 1 connected to an e-mail server and a network, wherein a step in a route segment notifies the project management component by sending an e-mail to the e-mail address of the project management component.

8. The project workflow system of claim 1 connected to an e-mail server and a network, wherein the project management component initiates a route segment by sending an e-mail to the e-mail address of the workflow component.

9. The project workflow system of claim 1, wherein changing a task changes the related route segment and the project route.

10. The project workflow system of claim 1, wherein a change to the task-to-task connections changes the connection of the route segments related to the tasks to reflect the change of the task-to-task connections.

11. A project workflow route which is constructed by dividing the project into tasks; determining a connection relationship among the tasks; relate to each task a route segment that implements the task process; and connecting the route segments in the same relationship as the connection of the related tasks.

12. The project workflow route of claim 11 connected to a project management system, wherein the completion of a route segment signifies the completion of the related task in the project management system.

13. The project workflow route of claim 11, wherein at the completion of a route segment related to a task, the next task is determined from the connection of tasks and the route segment related to the next task is initiated.

14. The project workflow route of claim 11, wherein a change to the task-to-task connections changes the connection of the route segments related to the tasks to reflect the change of the task-to-task connections.

15. The project workflow route of claim 11, wherein changing a task changes the related route segment and the project route.

16. A project management workflow system wherein a project is divided into tasks, the task-to-task connections determined, each task is related to a workflow route segment that implements the task process, wherein the route segment related to a task is executed in accordance to the task-to-task connections of the task.

17. The project management workflow system of claim 16, wherein at the completion of a route segment related to a task, the next task is determined from the task-to-task connections and the route segment related to the next task is initiated.

18. The project management workflow system of claim 16, wherein a change to the task-to-task connections changes the connection of the route segments related to the tasks to reflect the change of the task-to-task connections.

19. The project management workflow system of claim 16, wherein changing a task changes the related route segment and the project route.

20. The project management workflow system of claim 16 connected to a project management system, wherein the completion of a route segment signifies the completion of the related task in the project management system
